(19) United States
(12) Patent Application Publication
(10) Pub. No.: US 2022/0396261 A1
(43) Pub. Date: Dec. 15, 2022

(54) VEHICLE TRACKING SYSTEM

(71) Applicant: EMBEDTEK, LLC, Waukesha, WI (US)

(72) Inventor: Kent Tabor, Pewaukee, WI (US)

(21) Appl. No.: 17/839,899

(22) Filed: Jun. 14, 2022

Related U.S. Application Data
(60) Provisional application No. 63/210,913, filed on Jun. 15, 2021.

(51) Int. Cl. B60W 30/095; B60W 50/14; B60W 40/09

(52) U.S. Cl. CPC B60W 30/0956; B60W 30/0953; B60W 50/14; B60W 40/09; B60W 2554/4049; B60W 2554/4041; B60W 2050/146

(57) ABSTRACT

A system including a proximity monitor associated with an entity. The proximity monitor includes a communication interface, a memory, and an electronic processor. The communication interface receives first position state data and identification data associated with a neighboring entity. The electronic processor includes instructions to associate a first shape model with the neighboring entity based on the identification data, determine a first space occupied by the neighboring entity based on the first position state data and the first shape model, identify a proximity event based on the first space occupied by the neighboring entity relative to a position of the entity, and generate an alert based on the proximity event.

### BACKGROUND

Embodiments of the invention relate to tracking vehicles, and, more particularly, to a vehicle tracking system using location tracking and vehicle shape modeling.

Certain environments, such as an airport, construction site, work site, or the like, involve a large number of vehicles working together. Even experienced and highly trained individuals grow accustomed to working in synch with certain equipment, coworkers, or standard operating procedures and tend to operate using a mental autopilot. However, environments, such as an airport apron, are fast-paced and include many moving entities. One slight change, such as taking over for someone out sick, working with a new plane, driving a different vehicle, even just an off day, can change the rhythm and an individual's mental autopilot can fail, resulting in a collision between vehicles. For example, an operator of a baggage unloader may be accustomed to working with a 747 aircraft with a particular wing clearance. On a given day, the individual may find themselves working with a different aircraft having a lower wing clearance, but may have the conveyer ramp set at the height typical for the 747 aircraft. This conveyor may impact the wing of the aircraft due to the lower clearance. Collisions can cause serious injury and costly damage. For example, an aircraft involved in even a minor collision requires costly recertification to obtain flight clearance. The Flight Safety Foundation estimates that ramp accidents and incidents occur once every 1,000 departures on a worldwide basis. Reducing this number serves to protect the safety of personnel, aircraft, facilities, and equipment.

### SUMMARY

In one aspect, the invention provides a system including a proximity monitor associated with an entity. The proximity monitor includes a communication interface, a memory, and an electronic processor. The communication interface receives first position state data and identification data associated with a neighboring entity. The electronic processor includes instructions to associate a first shape model with the neighboring entity based on the identification data, determine a first space occupied by the neighboring entity based on the first position state data and the first shape model, identify a proximity event based on the first space occupied by the neighboring entity relative to a position of the entity, and generate an alert based on the proximity event.

In another aspect, the invention provides a method of proximity tracking. The method includes receiving, at a proximity monitor coupled to an entity, first position state data and identification data associated with a neighboring entity via a communication interface of the proximity monitor. The method also includes associating, via an electronic processor of the proximity monitor, a first shape model with the neighboring entity based on the identification data, determining a first space occupied by the neighboring entity based on the first position state data and the first shape model, identifying a proximity event based on the first space occupied by the neighboring entity relative to a position of the entity, and generating an alert based on the proximity event.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram illustrating a vehicle tracking system, according to some embodiments.

FIG. 2 is a block diagram of a proximity monitor, according to some embodiments.

FIG. 3 is a diagram illustrating a shape model for a vehicle with movable portions.

FIG. 4 is a flowchart of a method performed by a computing device for vehicle proximity tracking, according to some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways.

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used herein, “non-transitory computer-readable medium” includes all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

Also, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

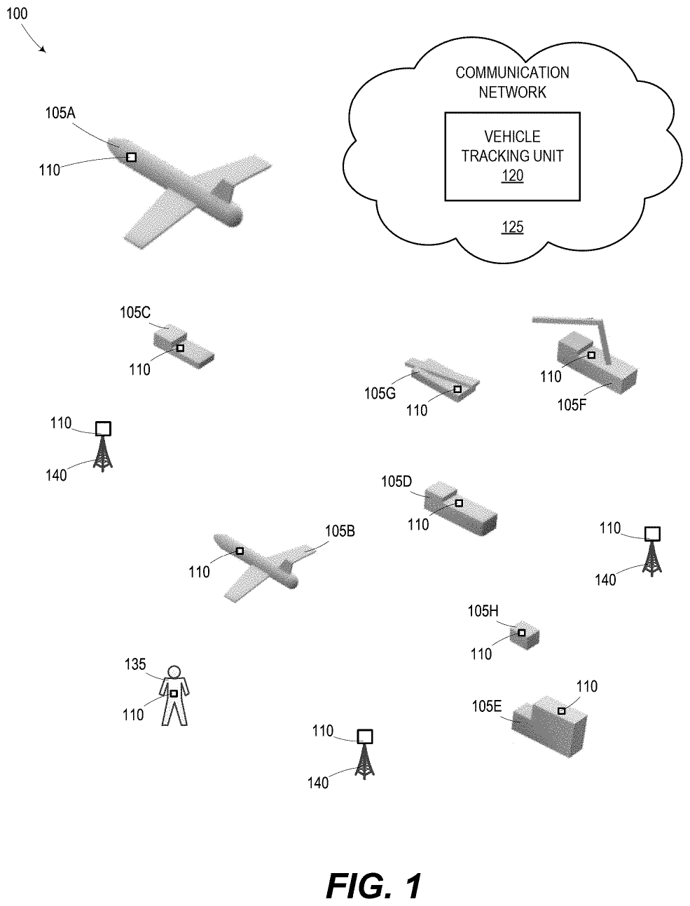

FIG. 1 is a diagram illustrating a vehicle tracking system 100, according to some embodiments. The vehicle tracking system 100 is used to identify proximity conditions between vehicles 105A-105H. In some embodiments, the vehicles 105A-105H are associated with a particular facility, work group, etc. In the illustrated example, the vehicles 105A-105H are vehicles typically found in an airport environment, such as a large aircraft 105A, a small aircraft 105B, a tug 105C, catering trucks 105D (down position), 105E (raised position), a de-icing truck 105F, a belt loader 105G, a service vehicle 105H (car, van, bus, etc.), or the like. Each vehicles 105A-105H is equipped with a proximity monitor 110 that determines if another vehicle 105A-105H comes within a proximity threshold. Each vehicle 105A-105H in the vehicle tracking system 100 is represented by a shape model.

In FIG. 1, the shape models of the vehicles 105A-105H are shown rather than the actual vehicles 105A-105H. The amount of detail of the shape models may vary. In some embodiments, the shape models are rough estimates of the dimensions of the vehicle 105A-105H, such as polygon shape models. The size of the constituent polygons may vary, which varies the granularity of the shape model. In some embodiments, shape models are detailed solid models. The shape model for a particular vehicle 105A-105H may represent the actual vehicle or a class of similar vehicles. In some embodiments, the shape model has multiple portions that have varying relative positions. For example, a belt loader with a conveyor may be modeled using a first portion for the vehicle body and a second portion for the conveyor, which may be raised and our extended relative to the vehicle body. Hence, over time, the shape model for the vehicle 105A-105H may vary depending on the position of the movable portions.

The proximity monitors 110 interface with a vehicle tracking unit 120 through a communication network 125 (e.g., WiFi, BLUETOOTH®, cellular, Internet, RF, Ultra Wideband (UWB), or the like). In some embodiments, the vehicle tracking unit 120 may be implemented as a cloud-based resource using a virtual computing environment. In some embodiments, the vehicle tracking unit 120 is a server. The proximity monitors 110 cooperate with the vehicle tracking unit 120 to identify and log proximity events between vehicles 105A-105H and to alert operators of the vehicles 105A-105H of potential collisions or proximity threshold violations. In some embodiments, each proximity monitor 110 identifies proximity events with respect to neighboring or adjacent vehicles or structures 105A-105H. In other embodiments, the vehicle tracking unit 120 receives position data from the proximity monitors 110 and generates alerts or logs events. In some embodiments, the proximity monitor 110 is mounted to the vehicle 105A-105H.

In some embodiments, an individual 135 may carry a proximity monitor 110 to facilitate alerts should the individual come within a proximity threshold of a vehicle 105A-105H. In some embodiments where a proximity monitor 110 is carried by a driver of the vehicle 105A-105H, proximity tracking may be disabled for the vehicle 105A-105H being operated. In some embodiments, a shape model is employed for an individual.

In some embodiments, a proximity monitor 110 is associated with a stationary reference point 140. Example stationary reference points 140 include buildings or fixed structures. Shape models may also be associated with the stationary reference points 140.

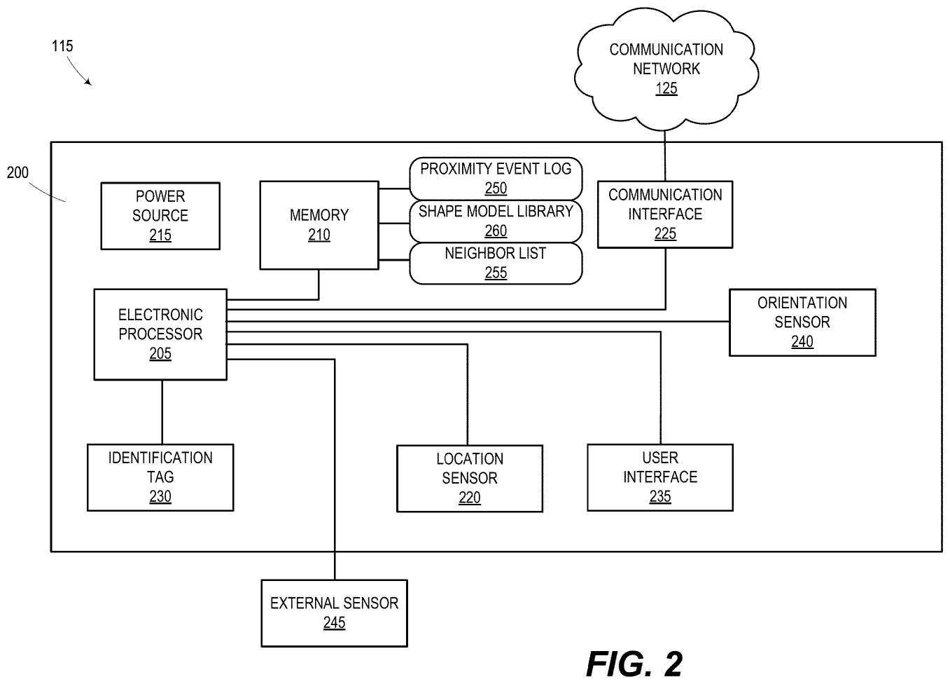

FIG. 2 is a block diagram of a proximity monitor 110, according to some embodiments. Each proximity monitor 110 may contain a housing 200. Such a housing 200 may be manufactured with any suitable materials for the environment in which the vehicles 105A-105H are present. As illustrated in FIG. 2, the proximity monitor 110 includes an electronic processor 205, a memory 210, a power source 215, a location sensor 220 (e.g., Global Positioning System (GPS) sensor), a communication interface 225, an identification tag 230, a user interface 235, and an orientation sensor 240. It should be appreciated that proximity monitor 110 may include any of numerous other types of sensors in addition to or instead of the above-described sensors. In some embodiments, the proximity monitor 110 interfaces with one or more external sensors 245. For example, the external sensor 245 may be a position sensor associated with a movable portion of the vehicle 105A-105H, such as a position sensor on the movable bed of a catering truck, a boom of a de-icing vehicle, a conveyor of a belt loader, or the like. Multiple position sensors may be provided for the vehicle 105A-105H. In some embodiments, the external sensor 245 may be a slave proximity monitor 110 attached to the movable portion of the vehicle 105A-105H that communicates its position to the master proximity monitor 110 attached the vehicle 105A-105H.

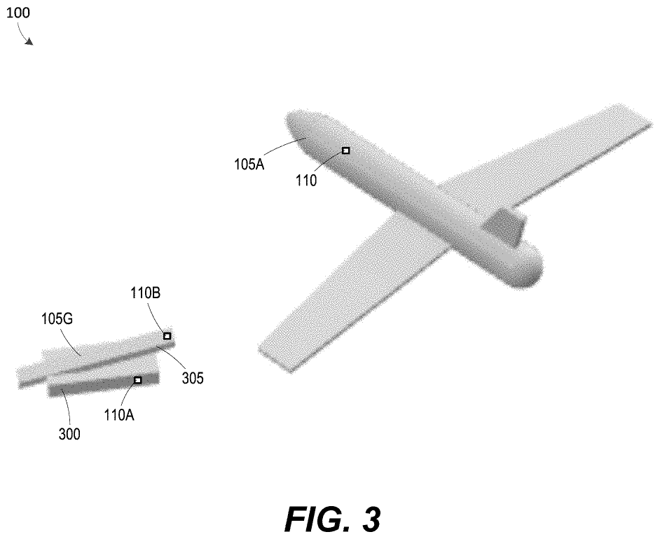

For example, FIG. 3 is a diagram illustrating a belt loader 105G approaching an aircraft 105A. The proximity monitor 110 of the aircraft 105A broadcasts its identity and position state (location, orientation, heading, speed, etc.). A master proximity monitor 110A on the body 300 of the belt loader 105G receives position state information from a slave proximity monitor 110B on the conveyor 305 and broadcasts its identity position state modified based on the position of the conveyor 305.

The memory 210 includes read only memory (ROM), random access memory (RAM), other non-transitory computer-readable media, or a combination thereof. The electronic processor 205 is configured to communicate with the memory 210 to store data and retrieve stored data. The electronic processor 205 is configured to receive instructions and data from the memory 210 and execute, among other things, the instructions. In particular, the electronic processor 205 executes instructions stored in the memory 210 to perform the methods described herein. The power source 215 provides power to the various components of the proximity monitor 110. In some embodiments, the memory 210 stores a proximity event log 250 that records events from the proximity detector 220. In some embodiments, the power source 215 includes a rechargeable device, such as a battery, a capacitor, a super capacitor, or the like. The power source 215 may charge rechargeable device using inductive charging or energy harvesting. In some embodiments, the power source 215 includes a replaceable battery. In some embodiments, the orientation sensor 240 includes an accelerometer, magnetometer, mercury switch, gyroscope, compass, or some combination thereof. In some embodiments, the orientation sensor 240 is an inertial measurement unit (IMU). In some embodiments, the orientation sensor 240 includes a magnetic compass or a pressure sensor.

The communication interface 225 provides communication between the electronic processor 205 and an external device, such as the vehicle tracking unit 120, over the communication network 125. In some embodiments, the communication interface 225 may include separate transmitting and receiving components. In some embodiments, the communication interface 225 is a wireless transceiver that encodes information received from the electronic processor 205, such as the proximity event log 250, into a carrier wireless signal and transmits the encoded wireless signal to the monitoring unit 120 over the communication network 125. The communication interface 235 also decodes information from a wireless signal received from the vehicle tracking unit 120 over the communication network 125 and provides the decoded information to the electronic processor 205.

In some embodiments, the user interface 235 includes one or more of input buttons, a display, a visual indicator (e.g., LED light), a vibration indicator, an audible indicator, or the like. In some embodiments, the user interface 235 is employed to set parameters for the proximity monitoring, such as a proximity threshold.

In general, the proximity monitor 110 uses position and shape model information for neighboring entities, such as the vehicles 105A-105H, individuals 135, and stationary elements 140 to identify proximity events. In some embodiments, the proximity monitor 110 stores a neighbor list 255 of nearby vehicles 105A-105H and a shape model library 260 indicating shape models for various vehicles 105A-105H in the memory 210. Upon identifying a current or ensuing proximity event, the proximity monitor 110 generates an alert and logs a proximity event in the proximity event log.

In general, the proximity monitor 110 uses position tracking to identify proximity events. In some embodiments, proximity events are identified for vehicles 105A-105H, individuals 135, or stationary elements 140. In some embodiments, the proximity monitor 110 uses a current position state in conjunction with a proximity threshold to generate a proximity event if the proximity threshold is violated. For example, a proximity threshold is defined for the entire vehicle 105A-105H based on the shape model. Based on the position state and the shape models, the system determines the presence of a neighboring or adjacent vehicle or structure 105A-105H within the proximity threshold. Overlap or collision (potential or actual) is identified by comparing the coordinates of the neighboring vehicle 105A-105H relative to the proximity threshold. If a neighboring vehicle 105A-105H is determined to violate the proximity threshold, a proximity event is generated. In some embodiments, the proximity threshold may vary for different portions of the vehicle. For example, the proximity threshold for the body 300 of the belt loader 105G illustrated in FIG. 3 may have a proximity threshold that is different (e.g. greater) than the proximity threshold for the conveyor 305. This may be due to the conveyor 305 being more likely to contact the aircraft 105A as it approaches.

In some embodiments, the proximity monitor 110 uses one or more predictive future position states to generate a proximity event responsive to the future position states indicating overlap or collision of the associated vehicles 105A-105H. Based on the position state and the shape models, overlap or collision is identified by comparing the coordinates of the vehicles 105A-105H relative to one another. The position states of the vehicles 105A-105H may be provided to a predictive filter, such as a Kalman filter, to predict the position states at a future time (e.g., 1 second, two seconds, five seconds. etc.). In some embodiments, the future time interval may change based on the speed of the vehicle 105A-105H. For example, the predicted future time interval for potential overlap or collision may be decreased as vehicle speed increases.

In general, the proximity thresholds or future position states are selected to provide adequate notice to an operator of the vehicle 105A-105H of the proximity event to avoid collision. In some embodiments, the proximity monitor 100 for each vehicle 105A-105H identifies proximity events for each identified neighboring vehicle 105A-105H. In operation, each vehicle 105A-105H broadcasts its position state and the proximity monitor 110 stores the identity and position state of the neighboring vehicles in the neighbor list 255. The proximity monitor 110 identifies a shape model from the shape model library 260 for itself and the neighboring vehicles 105A-105H based on their identities. The proximity monitor 110 generates a set of 3D coordinates (e.g., future or present, or both) based on the position state and position model that define the space occupied by the particular vehicle 105A-105H (i.e. self or neighboring vehicle). The proximity monitor 110 identifies the proximity events based on the 3D coordinates of its vehicle and those of the neighboring vehicles 105A-105H using a proximity threshold and current position state or using an overlap prediction using future position states.

In some embodiments, the identification of the proximity events is determined by the vehicle tracking unit 120. Each vehicle 105A-105H broadcasts its identity and position state to the vehicle tracking unit 120. The vehicle tracking unit 120 identifies the shape model for each vehicle 105A-105H and identifies proximity events using the threshold or future state techniques described above. In some embodiments, proximity events are identified for vehicles 105A-105H, individuals 135, or stationary elements 140, or any combination thereof.

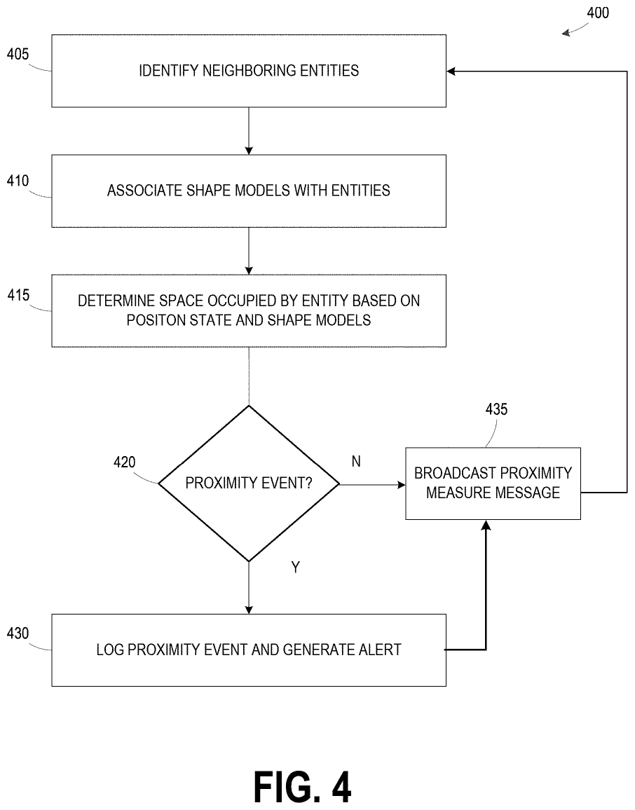

FIG. 4 is a flowchart of a method 400 performed by a computing device for vehicle proximity tracking, according to some embodiments. In some embodiments, the method 400 is performed by the electronic processor 205 of the proximity monitor 110. In some embodiments, the method 400 is performed by the vehicle tracking unit 120. In block 405, the proximity monitor 110 or vehicle tracking unit 120 identifies neighboring entities, such as one or more of the vehicles 105A-105H, individuals 135, or stationary entities 140. In some embodiments, the neighboring entities are identified based on received identity information and position state information from each entity.

In block 410, shape models are associated with the entities. In some embodiments, the proximity monitors 110 select shape models from the shape model library 260 based on the identity of the neighbors in the neighbor list 255. In some embodiments, the vehicle tracking unit 120 maintains a shape model library and associates the entities with the shape models.

In block 415, the space occupied by each entity is determined based on the position state and the shape models. The space occupied may represent the current time or a future time, as described above.

In block 420, a proximity event is identified based on the occupied space of the entities. For example, if the space between two entities is less than the proximity threshold or the future occupied spaces of the entities overlap, a proximity event is identified.

Responsive to the identification of the proximity event in block 420, the proximity event is logged and an alert is generated in block 430. If no proximity event is identified, the method 400 returns to block 405 for continued monitoring. In some embodiments, the proximity monitor 110 stores an entry in the proximity event log 250 including an identifier of the associated entity and a time stamp. In some embodiments, the proximity monitor 110 also logs the proximity measure. In some embodiments, the proximity monitor 110 may provide the alert as feedback using the user interface 238 (e.g., an audible tone, a vibration, a flashing visual indicator, a message on the display, etc). In some embodiments, the operator may acknowledge the proximity event by clicking one of the input buttons on the user interface 235.

In some embodiments, all of the proximity monitors 110 are simultaneously detecting proximity events, so there could be multiple detections of the same proximity events (i.e., the proximity monitors 110 detect each other). Entries in the proximity event log 250 may be aggregated for the duplicate events. In some embodiments, the aggregated data may be filtered to identify the proximity event generated by the multiple detections.

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

Various features and advantages of some embodiments are set forth in the following claims.

1. A system comprising:
a proximity monitor associated with an entity and including:
a communication interface configured to receive first position state data and identification data associated with a neighboring entity;
a memory; and
an electronic processor including instructions to:
associate a first shape model with the neighboring entity based on the identification data;
determine a first space occupied by the neighboring entity based on the first position state data and the first shape model;
identify a proximity event based on the first space occupied by the neighboring entity relative to a position of the entity; and
generate an alert based on the proximity event.

2. The system of claim 1, wherein the electronic processor is configured to:
associate a second shape model with the entity;
determine a second space occupied by the entity based on the second position state data associated with the entity and the second shape model; and
identify the proximity event based on the first and second spaces.

3. The system of claim 2, wherein the electronic processor is configured to identify the proximity event responsive to the first space associated with the neighboring entity being within a proximity threshold of the second space associated with the entity.

4. The system of claim 3, wherein the entity is a vehicle and the proximity threshold is defined for the entirety of the vehicle based on the second shape model.

5. The system of claim 2, wherein the electronic processor is configured to:
generate the first space using a predicted position state of the neighboring entity;
generate the second space using a predicted position state of the entity; and
generate the proximity event responsive to the first space overlapping the second space.

6. The system of claim 1, further comprising a vehicle tracking unit configured to receive position data from the proximity monitor to log the proximity event.

7. The system of claim 1, wherein the proximity monitor is associated with a stationary reference point and the neighboring entity is a movable object.

8. The system of claim 1, wherein the proximity monitor interfaces with an external sensor coupled to a movable portion of the entity.

9. The system of claim 1, wherein the proximity monitor interfaces with an external sensor coupled to a movable portion of the neighboring entity.

10. The system of claim 1, wherein the proximity monitor interfaces with an external sensor coupled to a movable portion of the entity and with another external sensor coupled to a movable portion of the neighboring entity.

11. The system of claim 1, wherein the proximity monitor is configured to broadcast identity and position state information associated with the entity via the communication interface, and to receive identity and position state information associated with the neighboring entity via the communication interface.

12. The system of claim 1, wherein the proximity event includes a predictive position state associated with one or both of the entity and the neighboring entity.

13. A method of proximity tracking, the method comprising:
receiving, at a proximity monitor coupled to an entity, first position state data and identification data associated with a neighboring entity via a communication interface of the proximity monitor;
associating, via an electronic processor of the proximity monitor, a first shape model with the neighboring entity based on the identification data;
determining a first space occupied by the neighboring entity based on the first position state data and the first shape model;
identifying a proximity event based on the first space occupied by the neighboring entity relative to a position of the entity; and
generating an alert based on the proximity event.

14. The method of claim 13, further comprising:
associating a second shape model with the entity;
determining a second space occupied by the entity based on the second position state data associated with the entity and the second shape model; and
identifying the proximity event based on the first and second spaces.

15. The method of claim 14, wherein identifying the proximity event includes determining the first space occupied by the neighboring entity being within a proximity threshold of the second space occupied by the entity.

16. The method of claim 15, wherein the entity is a vehicle, the method further comprising defining the proximity threshold for the entirety of the vehicle based on the second shape model.

17. The method of claim 14, further comprising:
generating the first space using a predicted position state of the neighboring entity;
generating the second space using a predicted position state of the entity; and
generating the proximity event responsive to the first space overlapping the second space.

18. The method of claim 17, further comprising:
adjusting the predicted position state of the entity in response to a change in speed of the entity, and
adjusting the predicted position state of the neighboring entity in response to a change in speed of the neighboring entity.

19. The method of claim 13, further comprising interfacing the proximity monitor with an external sensor coupled to a movable portion of the entity and with another external sensor coupled to a movable portion of the neighboring entity.
